(19) United States
(12) Patent Application Publication
(10) Pub. No.: US 2019/0235239 A1
(43) Pub. Date: Aug. 1, 2019

(54) LENS SYSTEM FOR HEAD-UP DISPLAY FOR AVOIDING GHOST IMAGE

(71) Applicant: SEKONIX CO., LTD., Dongducheon-si (KR)

(72) Inventors: Jin Ho Kim, Yongin-si (KR); Seung Ki Hong, Suwon-si Gyeonggi-do (KR); Jin Taek Oh, Suwon-si (KR)

(73) Assignee: SEKONIX CO., LTD., Dongducheon-si (KR)

(21) Appl. No.: 16/311,306

(22) PCT Filed: May 29, 2017
(86) PCT No.: PCT/KR2017/005570

§ 371 Date: Dec. 19, 2018

(30) Foreign Application Priority Data
Sep. 26, 2016 (KR) 10-2016-0123283

(51) Int. Cl. G02B 27/01; G02B 27/00; G02B 9/64

(52) U.S. Cl. CPC G02B 27/0101; G02B 27/0018; G02B 27/0149; G02B 2027/0152; G02B 2027/012; G02B 2027/015; G02B 9/64

(57) ABSTRACT

The present invention relates to a lens system for a head-up display. The technical gist of the present invention is to provide a lens system for a head-up display for avoiding a ghost image, comprising: a first group of lenses positioned toward a screen with reference to a diaphragm; and a second group of lenses arranged toward an image element, wherein, among the second groups of lenses, a lens positioned toward the image element and in direct proximity to the diaphragm is shaped to be concave toward the screen; the first group of lenses have negative refractive power; the second group of lenses have positive refractive power; and |f1|>|f2| is satisfied (wherein f1 refers to the effective focal distance of the first group of lenses, and f2 refers to the effective focal distance of the second group of lenses). Accordingly, the present invention advantageously provides a lens system for a head-up display for avoiding a ghost image, which is designed such that a lens arranged in proximity to the diaphragm is formed to be concave toward the screen, and, by avoiding generation of a ghost image, high-resolution images can be provided.

### TECHNICAL FIELD

Example embodiments relate to a lens system for a head-up display and, more particularly, to a lens system for a head-up display configured to prevent generation of a ghost image and provide a high-resolution image by forming a lens adjacent to a diaphragm to be concave towards a screen.

### BACKGROUND ART

A small camera module has been widely used by recent demands for miniaturization and high resolution of a device such as a portable terminal, a drone, an action-cam, a head-mounted display, a head-up display, and the like.

Among these devices, a head-up display is mainly used to provide a user with device information and environment information about surroundings of the user within a range not deviating from a main visual field of the user.

For example, a head-up display device for a vehicle may be used to effectively provide a driver with travel information of the vehicle and environment information about situations around the vehicle, while ensuring safety of the driver. This head-up display device may provide such information on a front side of the driver, for example, a windshield of the vehicle, while the vehicle is travelling. In general, the head-up display device may allow an image from a projector to be projected as a virtual image onto the windshield of the vehicle using a head-up display mirror.

In addition, there is a growing demand for easier installation of such a head-up display device in a vehicle, and miniaturization and high resolution of the head-up display, in order to improve its performance. Thus, a projector for the head-up display device may be equipped with a lens system including five or more lenses to achieve the high resolution.

However, the lens system may generate an undesirable ghost image in a screen of a projected image that generates the virtual image. Such a ghost image may be generated in an actual image viewed by the driver, and thus may cause an issue when applying the lens system to the head-up display device requiring a high image quality and a high contrast ratio.

In addition, this lens system may be affected by heat generated from internal elements as the head-up display device becomes more compact in size. For example, when an internal temperature of the vehicle increases or a temperature of the internal elements increases, a change in refractive power of the lenses may become more significant and an image may not be desirably projected as designed, and accordingly a distorted image may be finally produced.

In general, a desirable effective focal length may be obtained at a room temperature of 20° C. However, when the temperature increases, an effective focal length of each lens may change, and the internal temperature may increase as a period of time for which the product is used increases. Thus, the effective focal length may change, and thus a desired image quality may not be achieved.

Related existing technology may design a deviation in effective focal length of a first group of lenses arranged towards a screen from a diaphragm (or, a stop) of a compact camera system, and a deviation in effective focal length of a second group of lenses arranged towards an image element to be all inclined to a positive direction, and thus a more distorted image may be generated and also some advantageous properties such as high resolution, high performance, and miniaturization may not be readily achieved.

In addition, an undesirable ghost image may be generated in a screen of a projected image that generates a virtual image in such a lens system. It is generally known that such a ghost image is generated by a planar lens.

That is, as illustrated in FIG. 1, a planar lens of an existing lens system for a head-up display may function as a planar mirror, and light may be reflected again in a direction in which the light is introduced and then be introduced again into a digital mirror device (DMD) to enter a surface of an image element, thereby generating a ghost image.

Such a ghost image may be highly likely to be generated in a planar shape of a lens adjacent to a diaphragm. FIG. 2a is an actual ghost image generated by such an existing lens system, and FIG. 2b is a simulated image of an actual ghost image generated by the existing lens system. Such an image may be generated in an actual image viewed by a driver, causing a potentially critical issue to a head-up display device.

### DISCLOSURE OF INVENTION

### Technical Goals

Example embodiments provide a lens system for a head-up display that may prevent generation of a ghost image and provide a high-resolution image by forming a lens adjacent to a diaphragm to be concave towards a screen.

### Technical Solutions

According to an example embodiment, there is provided a lens system for a head-up display for preventing a ghost image, the lens system including a first group of lenses arranged towards a screen from a diaphragm and a second group of lenses arranged towards an image element. A lens disposed immediately adjacent to the image element of the diaphragm among the lenses of the second group may be formed to be concave towards the screen. The first group of lenses may have a negative refractive power, and the second group of lenses may have a positive refractive power. The lens system may be configured to satisfy |f1|>|f2|, wherein f1 denotes an effective focal length of the first group and f2 denotes an effective focal length of the second group.

The lens system may include the first group of lenses positioned towards the screen from the diaphragm and the second group of lenses positioned towards the image element, in which a first lens, a second lens, a third lens, and a fourth lens of the first group are arranged from the screen along an optical axis, and a fifth lens, a sixth lens, a seventh lens, and an eighth lens of the second group are arranged from the screen along the optical axis. The fifth lens may be formed to be concave towards the screen.

A curvature radius of a lens surface of the fifth lens facing the screen may be −100 millimeters (mm) to −30 mm.

The curvature radius of the lens surface of a fifth lens facing the screen may be −100 mm to −30 mm. Lens surfaces of the first through fourth lenses, the sixth lens, and the seventh lens facing the image element, and lens surfaces of the first through fourth lenses, the sixth lens, and the seventh lens facing the screen may not be all planar.

Each of the fifth lens, the seventh lens, and the eighth lens of the second group may satisfy 40.00<P<70.00 in which P denotes a refractive power.

The fifth lens, the seventh lens, and the eighth lens may have a refractive power greater than a refractive power of the second lens and the third lens. The fifth lens, the seventh lens, and the eighth lens may have a negative DN/DT (abs.) (temperature coefficients of refractive index [10⁻⁶/° C. at 632.8 nm]) value in a temperature range from 60° C. to 80° C.

A material may be desirably selected from a group of materials having a DN/DT (abs.) value in a range from −7.8 to −3.3.

In a temperature range from −40° C. to −20° C., the first lens may be selected from a group of materials having a DN/DT (abs.) value of 0.3 to 1.0, the second lens may be selected from a group of materials having a DN/DT (abs.) value of −1.6 to −1.0, the third lens may be selected from a group of materials having a DN/DT (abs.) value of 0.1 to 0.5, the fourth lens may be selected from a group of materials having a DN/DT (abs.) value of −1.4 to −0.8, the fifth lens may be selected from a group of materials having a DN/DT (abs.) value of −7.7 to −7.1, the sixth lens may be selected from a group of materials having a DN/DT (abs.) value of −1.2 to −0.6, the seventh lens may be selected from a group of materials having a DN/DT (abs.) value of −7.7 to −7.1, and the eighth lens may be selected from a group of materials having a DN/DT (abs.) value of −4.9 to −4.3.

In the temperature range from 60° C. to 80° C., the first lens may be selected from a group of materials having a DN/DT (abs.) value of 1.7 to 2.3, the second lens may be selected from a group of materials having a DN/DT (abs.) value of 0.2 to 0.8, the third lens may be selected from a group of materials having a DN/DT (abs.) value of 1.4 to 2.0, the fourth lens may be selected from a group of materials having a DN/DT (abs.) value of 0.4 to 1.0, the fifth lens may be selected from a group of materials having a DN/DT (abs.) value of −7.3 to −6.7, the sixth lens may be selected from a group of materials having a DN/DT (abs.) value of 0.5 to 1.1, the seventh lens may be selected from a group of materials having a DN/DT (abs.) value of −7.3 to −6.7, and the eighth lens may be selected from a group of materials having a DN/DT (abs.) value of −3.9 to −3.3.

The lens system may be configured to satisfy −3.5<f1/f2<0 in which f1 denotes the effective focal length of the first group and f2 denotes the effective focal length of the second group.

The lens system may be configured to satisfy f2/F>1.1 in which f2 denotes the effective focal length of the second group and F denotes an overall effective focal length of the lens system.

According to another example embodiment, there is provided a lens system for a head-up display for preventing a ghost image, the lens system including a first group of lenses arranged towards a screen from a diaphragm and a second group of lenses arranged towards an image element. A first lens, a second lens, a third lens, and a fourth lens of the first group may be arranged from the screen along an optical axis. A fifth lens, a sixth lens, a seventh lens, and an eighth lens of the second group may be arranged from the screen along the optical axis. The first lens may be formed in a meniscus shape and have a negative refractive power. The second lens may be formed to be convex towards the image element and have a positive refractive power. The third lens may be formed in a meniscus shape and have a positive refractive power. The fourth lens may be formed in a meniscus shape and have a negative refractive power. The fifth lens may be formed to be concave towards the screen and have a positive refractive power. The sixth lens may be formed to be concave towards the image element or the screen and have a negative refractive power. The seventh lens may be formed to be convex towards the image element and have a positive refractive power. The eighth lens may be formed to be convex towards the screen and have a positive refractive power. A curvature radius of a lens surface of the fifth lens facing the screen may be −100 millimeters (mm) to −30 mm, and the first through eighth lenses may be formed of a glass material.

The first through eighth lenses may desirably be spherical lenses.

### Advantageous Effects

According to example embodiments described herein, there is provided a lens system for a head-up display that is designed to prevent generation of a ghost image and provide a high-resolution image by forming a lens disposed adjacent to a diaphragm to be concave towards a screen.

According to example embodiments described herein, there is provided a compact lightweight lens system for a head-up display that includes a lens array including a total of eight lenses, the lens array including a first group of lenses arranged towards a screen from a diaphragm and a second group of lenses arranged towards an image element.

According to example embodiments described herein, there is provided a lens system for a head-up display that is designed to prevent generation of a ghost image and provide a high-resolution image by forming a fifth lens disposed adjacent to a diaphragm to be concave towards a screen.

According to example embodiments described herein, there is provided a high-resolution and high-performance lens system for a head-up display that is designed to prevent generation of a ghost image, satisfy a thermal compensation characteristic, correct a distortion, and provide a stable image despite a change in temperature, by setting a refractive power of each of first through eighth lenses and setting a DN/DT value for a lens having a relatively high refractive power, and forming a shape of the fifth lens to be concave towards a screen.

### BRIEF DESCRIPTION OF DRAWINGS

FIG. 1 is a diagram illustrating an example of how a ghost image is generated by an existing lens system for a head-up display.

FIG. 2a is an actual ghost image generated by the lens system of FIG. 1.

FIG. 2b is a simulated image of an actual ghost image generated by the lens system of FIG. 1.

FIGS. 3 and 5 are diagrams illustrating examples of a lens system for a head-up display according to an example embodiment.

FIGS. 4 and 6 are simulated images of ghost images generated by the lens systems of FIGS. 3 and 5, respectively.

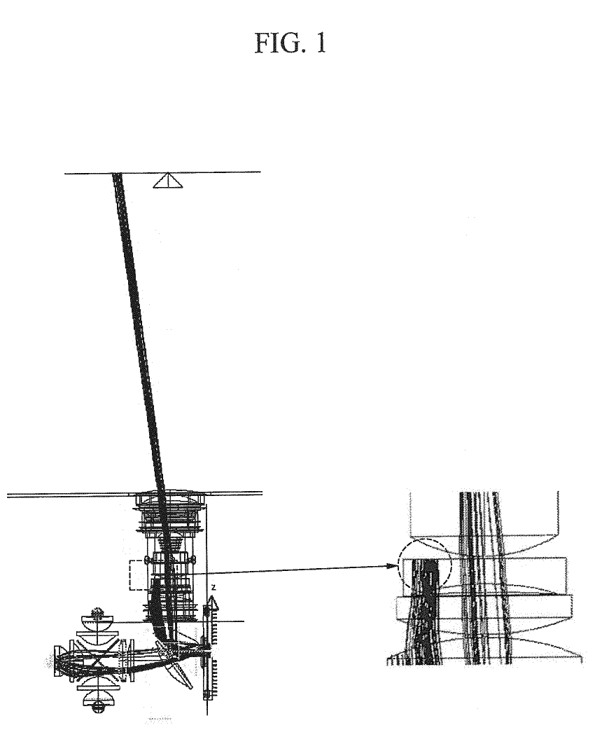

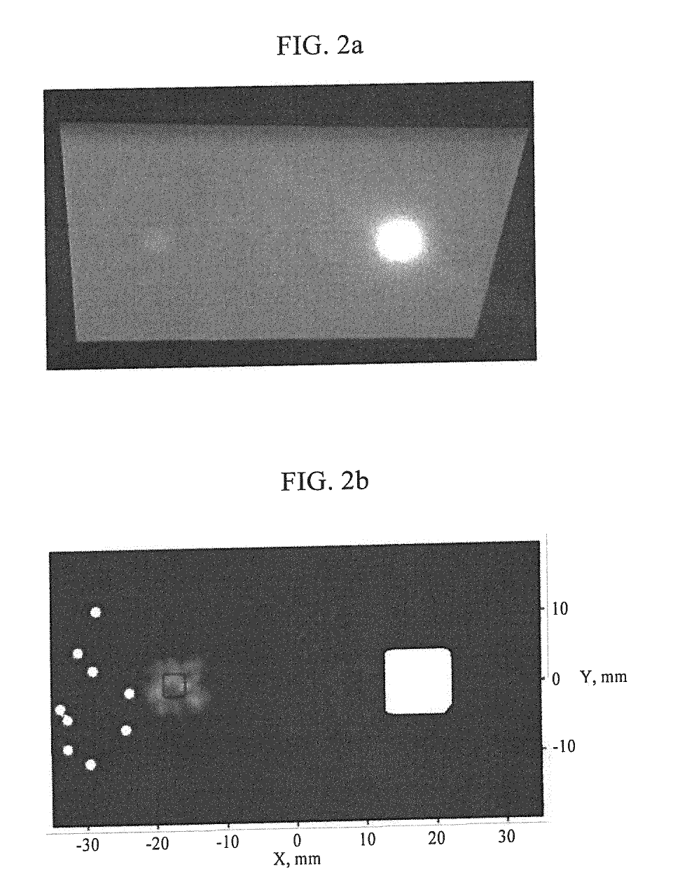

### BEST MODE FOR CARRYING OUT THE INVENTION

Example embodiments of the present disclosure to be described hereinafter relate to a lens system for a head-up display. The lens system for a head-up display will be hereinafter referred to as a head-up display lens system, or simply as a lens system. The lens system may be configured to prevent generation of a ghost image and provide a high-resolution image by forming a lens disposed adjacent to a diaphragm to be concave towards a screen.

For example, in a case of a head-up display lens system including a total of eight lenses, the lens system may be configured to prevent generation of a ghost image and provide a high-resolution image by forming a fifth lens disposed adjacent to a diaphragm among the eight lenses to be concave towards a screen.

The lens system may be designed to have high-resolution and high-performance and to be lightweight in volume and compact in size, and prevent the generation of a ghost image, satisfy a thermal compensation characteristic, and provide a stable image despite a change in temperature, by setting a refractive power of the first through eighth lenses and a DN/DT value for a lens having a relatively high refractive power, and forming the fifth lens to be concave towards the screen.

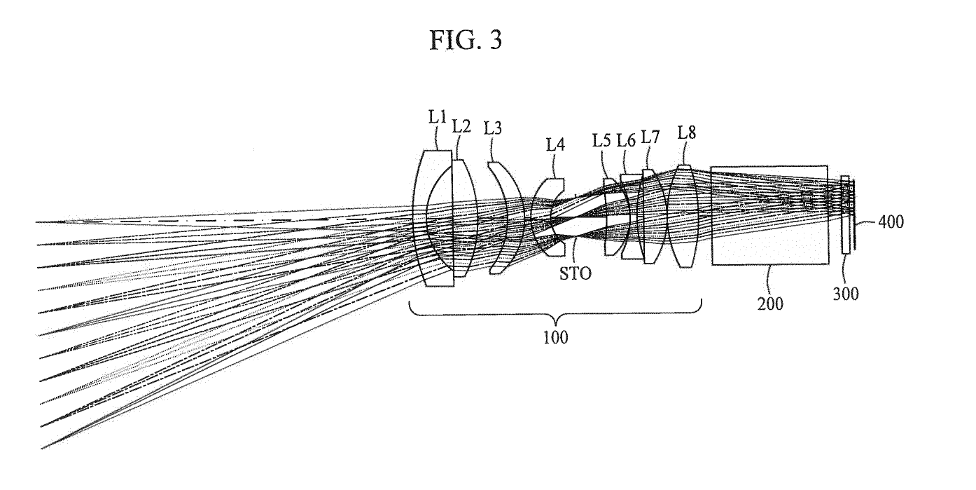

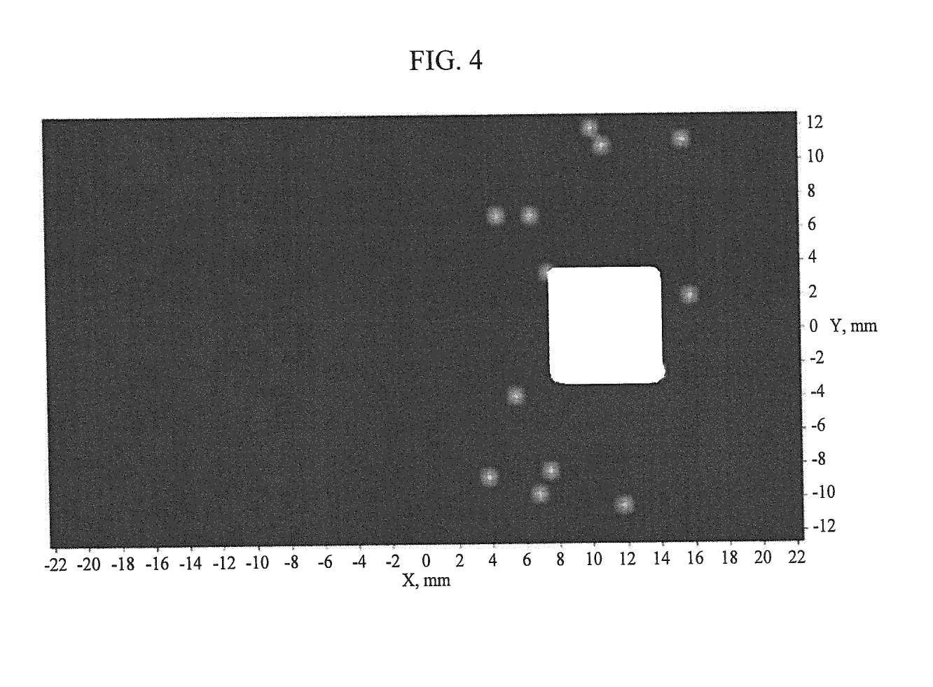

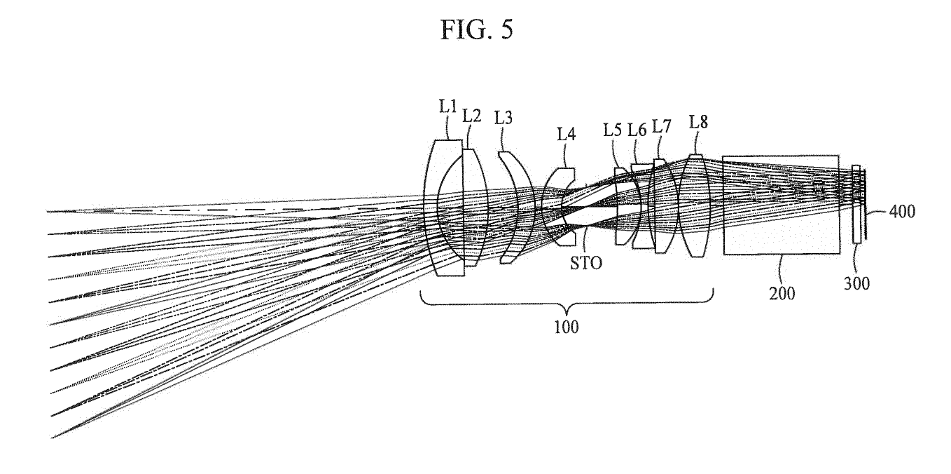

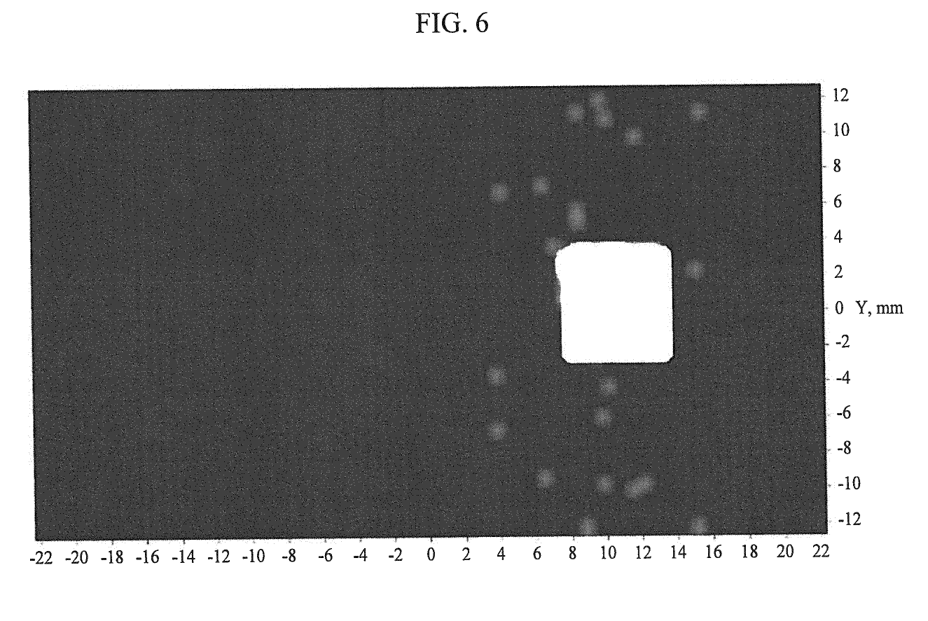

Hereinafter, the example embodiments will be described in detail with reference to the accompanying drawings. FIGS. 3 and 5 are diagrams illustrating examples of a head-up display lens system according to an example embodiment. FIGS. 4 and 6 are simulated images of ghost images generated by the lens systems of FIGS. 3 and 5, respectively.

According to an example embodiment, a head-up display lens system includes a first group of lenses arranged towards a screen from a diaphragm and a second group of lenses arranged towards an image element. Among the lenses of the second group, a lens disposed immediately adjacent to the image element of the diaphragm may be formed to be concave towards the screen, and thus the head-up display lens system may prevent a ghost image.

The first group of lenses has a negative refractive power, and the second group of lenses has a positive refractive power. The lens system may satisfy |f1|>|f2| in which f1 denotes an effective focal length of the first group and f2 denotes an effective focal length of the second group.

In general, in an existing head-up display lens system, a lens disposed adjacent to a diaphragm of the lens system is formed in a planar shape, and thus light may be reflected again in a direction in which the light is introduced to enter a surface of an image element, and a ghost image may thus be generated. According to an example embodiment, by forming a lens immediately adjacent to a diaphragm towards an image element to be concave towards a screen, it is possible to prevent generation of a ghost image.

The head-up display lens system includes a plurality of lenses. The lenses are classified into a first group of lenses arranged towards a screen from a diaphragm, and a second group of lenses arranged towards an image element. The first group of lenses has a negative refractive power, and the second group of lenses has a positive refractive power. The head-up display lens system may be designed to satisfy |f1|>|f2| in which f1 denotes an effective focal length of the first group and f2 denotes an effective focal length of the second group, and thus more effectively prevent light from being reflected in a direction in which the light is introduced and then entering a surface of the image element.

A total number of lenses of a lens array included in this lens system may be selected from, for example, five, six, seven, eight, and the like based on a purpose of use and resolution.

An example of the lens system using eight lenses will be described hereinafter.

As illustrated, the head-up display lens system includes a first group of lenses arranged towards a screen from a diaphragm STO, and a second group of lenses arranged towards an image element 400. The first group includes a first lens L1, a second lens L2, a third lens L3, and a fourth lens L4, which are arranged from the screen along an optical axis. The second group includes a fifth lens L5, a six lens L6, a seventh lens L7, and an eighth lens L8, which are arranged from the screen along the optical axis. Among these lenses, the fifth lens L5 is formed to be concave towards the screen.

The head-up display lens system includes the first group of lenses arranged towards the screen from the diaphragm STO, and the second group of lenses arranged towards the image element 400. The first group includes the first lens L1, the second lens L2, the third lens L3, and the fourth lens L4, which are arranged from the screen along the optical axis. The second group includes the fifth lens L5, the sixth lens L6, the seventh lens L7, and the eighth lens L8, which are arranged from the screen along the optical axis. The first lens L1 is formed in a meniscus shape and has a negative refractive power. The second lens L2 is formed to be convex towards the image element 400 and has a positive refractive power. The third lens L3 is formed in a meniscus shape and has a positive refractive power. The fourth lens L4 is formed in a meniscus shape and has a negative refractive power. The fifth lens L5 is formed to be concave towards the screen and has a positive refractive power. The sixth lens L6 is formed to be concave towards the image element 400 or the screen, and has a negative refractive power. The seventh lens L7 is formed to be convex towards the image element 400 and has a positive refractive power. The eighth lens L8 is formed to be convex towards the screen and has a positive refractive power. The first through eighth lenses L through L8 may be formed of an optical material, for example, glass or plastic.

As illustrated in FIGS. 3 and 5, the head-up display lens system includes the screen (not shown) disposed at a leftmost side, a lens array 100, a total internal reflection prism 200, a cover glass 300, and the image element 400.

The lens array 100 included in the head-up display lens system may be formed to allow positive and negative refractive powers of the lenses to be uniformly distributed, and thus enable the head-up display lens system to have a high resolution and high performance.

In detail, the first lens L1, the second lens L2, the third lens L3, and the fourth lens L4, which are arranged towards the screen from the diaphragm STO, are included in the first group. The fifth lens L5, the sixth lens L6, the seventh lens L7, and the eighth lens L8, which are arranged towards the image element 400 from the diaphragm STO, are included in the second group.

In the first group, the first lens L1 is formed in a meniscus shape and has a negative refractive power, the second lens L2 is formed to be convex towards the image element 400 and has a positive refractive power, the third lens L3 is formed in a meniscus shape and has a positive refractive power, and the fourth lens L4 is formed in a meniscus shape and has a negative refractive power. The shapes and refractive powers of the lenses are appropriately distributed as described in the foregoing such that the lens system may be formed to be compact in size, a distortion may be corrected, and a high resolution may be maintained.

In the second group, the fifth lens L5 is formed to be concave towards the screen and has a positive refractive power, the sixth lens L6 is formed to be concave towards the image element 400 or the screen and has a negative refractive power, the seventh lens L7 is formed to be convex towards the image element 400 and has a positive refractive power, and the eighth lens L8 is formed to be convex towards the screen and has a positive refractive power. The shapes and refractive powers of the lenses are appropriately distributed as described in the foregoing such that a ray of light passing through the diaphragm STO may reach the image element 400, and the lens system may be formed to be compact in size and to have a high resolution.

In addition, the first through eighth lenses L1 through L8 may be formed of a glass material such that a change in characteristic or property occurring due to a change in temperature may be reduced, or alternatively, minimized, and a change in optical performance of a lens by a thermal change may be reduced, or alternatively, minimized.

As described above, in an existing head-up display lens system, a lens adjacent to a diaphragm is formed in a planar shape, and thus light is reflected in a direction in which the light is introduced to enter a surface of an image element, which may result in generation of a ghost image. However, according to an example embodiment, the fifth lens L5 disposed adjacent to the diaphragm STO is formed to be concave towards the screen to prevent the generation of a ghost image.

In addition, the first group of lenses has a negative refractive power and the second group of lenses has a positive refractive power, and the head-up display lens system satisfies |f1|>|f2| in which f1 denotes an effective focal length of the first group and f2 denotes an effective focal length of the second group, in order to prevent light from being reflected in a direction in which the light is introduced and minimize such reflection.

In the examples, the fifth lens L5 is formed to be concave towards the screen, and a curvature radius of a lens surface facing the screen may be desirably in a range from −100 millimeters (mm) to −30 mm. The range of the curvature radius of the fifth lens L5 may be a range enabling a lens to have a concave shape while enabling the lens system to maintain a required performance.

In addition, a planar lens may be more likely to generate a ghost image, and thus the curvature radius of the lens surface of the fifth lens L5 facing the screen may be designed to be in the range from −100 mm to −30 mm, and lens surfaces of the first through fourth lenses L1 through L4, the sixth lens L6, and the seventh lens L7 facing the image element 400 and screen may be formed not to be in a planar shape, but to be in a spherical shape, a concave or convex shape, a meniscus shape, and the like.

In addition, each of the fifth lens L5, the seventh lens L7, and the eighth lens L8 of the second group may be formed of a material desirably selected from a group of materials having a positive focal length, and a positive refractive power relatively greater than those of the second lens L2 and the third lens L3. In detail, each of the fifth lens L5, the seventh lens L7, and the eighth lens L8 of the second group has a refractive power satisfying 40.00<P<70.00 in which P denotes the refractive power.

In addition, the fifth lens L5, the seventh lens L7, and the eighth lens L8 of the second group may be formed of a material desirably selected from a group of materials having a negative DN/DT (abs.) (temperature coefficients of refractive index [10⁻⁶/° C. at 632.8 nm]) value at a high temperature, for example, in a temperature range from 60° C. to 80° C. In detail, the material may be desirably selected from materials having a DN/DT (abs.) value in a range from −7.8 to −3.3.

In a temperature range from −40° C. to −20° C., the first lens L1 may be desirably selected from materials having a DN/DT (abs.) value of 0.3 to 1.0, the second lens L2 may be desirably selected from materials having a DN/DT (abs.) value of −1.6 to −1.0, the third lens L3 may be desirably selected from materials having a DN/DT (abs.) value of 0.1 to 0.5, the fourth lens L4 may be desirably selected from materials having a DN/DT (abs.) value of −1.4 to −0.8, the fifth lens L5 may be desirably selected from materials having a DN/DT (abs.) value of −7.7 to −7.1, the sixth lens L6 may be desirably selected from materials having a DN/DT (abs.) value of −1.2 to −0.6, the seventh lens L7 may be desirably selected from materials having a DN/DT (abs.) value of −7.7 to −7.1, and the eighth lens L8 may be desirably selected from materials having a DN/DT (abs.) value of −4.9 to −4.3.

In the temperature range from 60° C. to 80° C., the first lens L1 may be desirably selected from materials having a DN/DT (abs.) value of 1.7 to 2.3, the second lens L2 may be desirably selected from materials having a DN/DT (abs.) value of 0.2 to 0.8, the third lens L3 may be desirably selected from materials having a DN/DT (abs.) value of 1.4 to 2.0, the fourth lens L4 may be desirably selected from materials having a DN/DT (abs.) value of 0.4 to 1.0, the fifth lens L5 may be desirably selected from materials having a DN/DT (abs.) value of −7.3 to −6.7, the sixth lens L6 may be desirably selected from materials having a DN/DT (abs.) value of 0.5 to 1.1, the seventh lens L7 may be desirably selected from materials having a DN/DT (abs.) value of −7.3 to −6.7, and the eighth lens L8 may be desirably selected from materials having a DN/DT (abs.) value of −3.9 to −3.3.

In general, a glass material may have a refractive index that increases finely as a temperature increases, and most lenses may have a positive DN/DT value. According to an example embodiment, the lens array 100 may be formed by verifying a refractive power of each lens, and selecting a material having a negative DN/DT value at a high temperature, for example, 60° C. to 80° C., for a lens having a relatively great refractive power, for example, the fifth lens L5, the seventh lens L7, and the eighth lens L8, among lenses having a positive focal length.

This is based on a characteristic of a lens that a focal length is forced to change by heat, and the change in focal length by a change in length of the lens at a high temperature is inversely compensated for.

Such a thermal compensation characteristic may not be greatly dependent on a length and a thickness of a lens, and be determined by, for example, a DN/DT value of a material for a lens, a refractive power of the lens, a negative/positive compensation for a refractive power of each group of lenses, and the like.

Thus, by restricting a refractive power of a lens to a desired value while designing the lens system, and selecting a lens based on a characteristic that a DN/DT value differs from each material, it is thus possible to control a variation in focal length.

In addition, the head-up display lens system may satisfy −3.5<f1/f2<0 in which f1 denotes the effective focal length of the first group and f2 denotes the effective focal length of the second group.

Thus, by setting the effective focal length of the second group with respect to the effective focal length of the first group, it is possible to adjust a size of the lens system based on a ratio of the respective effective focal lengths, and reduce the size of the lens system when the respective effective focal lengths of the groups are similar.

In addition, the head-up display lens system may satisfy f2/F>1.1 in which f2 denotes the effective focal length of the second group and F denotes an overall effective focal length of the lens system.

Thus, by setting the effective focal length of the second group with respect to the overall effective focal length of the lens system, and setting an overall focal length of the lens system to be shorter than a focal length of the second group, it is possible to construct the head-up display lens system to be smaller in size.

Further, the head-up display lens system may satisfy 0.5<t1/t2<1.5 in which t1 denotes a distance from an object surface of the first lens L1 to the diaphragm STO, and t2 denotes a distance from the diaphragm STO to a top surface.

A length, or a distance, from the diaphragm STO to the image element 400 does not greatly differ from a length, or a distance, from the screen of the first lens L to the diaphragm STO, and thus a distortion of the lens system may be compensated for as the distances of t1 and t2 are equal.

Further, the head-up display lens system may satisfy E6/T6<3.0 in which E6 denotes a thickness of a portion on which an outermost ray of light of the second lens L2 is incident, and T6 denotes a thickness of a center of the sixth lens L6.

This defines a thickness of an edge, or an edge thickness, and a thickness of the center, or a center thickness, of the sixth lens L6, and it is thus possible to reduce or equalize sensitivities when manufacturing the lenses, and improve a tolerance and performance.

The first through eighth lenses, L1 through L8 as illustrated, of the head-up display lens system may be spherical lenses.

As described above, the head-up display lens system provided herein may be configured to prevent generation of a ghost image and provide a high-resolution image by forming a fifth lens disposed adjacent to a diaphragm to be concave towards a screen.

As described above, the head-up display lens system provided herein may be configured to prevent generation of a ghost image, satisfy a thermal compensation characteristic, and correct a distortion, and may thus be designed to have a high resolution and a high performance and to be compact in size and lightweight in volume, by setting refractive powers of first through eighth lenses and setting a DN/DT value for a lens having a relatively high refractive power, and by forming the fifth lens to be concave towards a screen.

Hereinafter, example embodiments will be described in detail.

FIGS. 3 and 5 are diagrams illustrating examples of a head-up display lens system according to an example embodiment. FIG. 5 illustrates a lens system of which an overall length and a thickness of a lens are set to be different from those of the lens system illustrated in FIG. 3. A curvature radius of the fifth lens L5 is −100 mm in the example illustrated in FIG. 3, and a curvature radius of the fifth lens L5 is −40 mm in the example illustrated in FIG. 5.

FIGS. 4 and 6 are simulated images of ghost images generated by the lens systems of FIGS. 3 and 5, respectively. Referring to the simulated images, it is verified that the generation of a ghost image is reduced, or alternatively, minimized.

As illustrated, the lens system includes a lens array 100 in which a first lens L1, a second lens L2, a third lens L3, a fourth lens L4, a diaphragm STO, a fifth lens L5, a sixth lens L6, a seventh lens L7, and an eighth lens L8 are arranged in sequential order from a screen along an optical axis, a total internal reflection prism 200, a cover glass 300, and an image element 400, which are arranged in sequential order.

Table 1 below indicates a refractive power of each of the lenses in the lens array 100 illustrated in FIG. 3.

TABLE 1

| Lens number | Retractive power | |
|---|---|---|
| L1 | −45.53 | D |
| L2 | 36.38 | D |
| L3 | 11.37 | D |
| L4 | −32.42 | D |
| L5 | 66.86 | D |
| L6 | −89.36 | D |
| L7 | 44.36 | D |
| L8 | 53.13 | D |

Individually, the first lens L1 is formed in a meniscus shape, the second lens L2 is formed to be convex towards the image element 400, the third lens L3 is formed in a meniscus shape, the fourth lens L4 is formed in a meniscus shape, the fifth lens L5 is formed to be concave towards the screen, the sixth lens L6 is formed to be concave towards the image element 400 and the screen, the seventh lens L7 is formed to be convex towards the image element 400, and the eighth lens L8 is formed to be convex towards the screen.

Table 2 below indicates a material of each of the lenses, and all the lenses L1 through L8 are formed of a glass material under respective trade names of HOYA.

TABLE 2

| Lens number | Material |
|---|---|
| L1 | LAC10_HOYA |
| L2 | EFD1_HOYA |
| L3 | BACD4_HOYA |
| L4 | EFD4_HOYA |
| L5 | FCD515_HOYA |
| L6 | EF1_HOYA |
| L7 | FCD515_HOYA |
| L8 | PCD4_HOYA |

Table 3 below indicates a DN/DT value of each of the lenses at a low temperature and at a high temperature. The low temperature is in a range from −40° C. to −20° C., and the high temperature is in a range from 60° C. to 80° C.

TABLE 3

| Lens number | DN/DT (−40/−20) | DN/DT (+60/+80) |
|---|---|---|
| L1 | 0.7 | 2.0 |
| L2 | −1.3 | 0.5 |
| L3 | 0.2 | 1.7 |
| L4 | −1.1 | 0.7 |
| L5 | −7.4 | −7.0 |
| L6 | −0.9 | 0.8 |
| L7 | −7.4 | −7.0 |
| L8 | −4.6 | −3.6 |

Table 4 below indicates an effective focal length of each of the lenses, an overall effective focal length F of the lens array 100, and respective effective focal lengths of the first group and the second group.

TABLE 4

| Lens number | Focal length | Group focal length | Overall focal length |
|---|---|---|---|
| L1 | −21.961709 | First group | (L1-L8) 10.5812 |
| L2 | 27.487787 | (L1-L4) −39.0705 | |
| L3 | 87.937213 | | |
| L4 | −30.849654 | | |
| L5 | 14.95554 | Second group | |
| L6 | −11.188767 | (L5-L8) 12.3707 | |
| L7 | 22.545072 | | |
| L8 | 18.820025 | | |

As indicated in Table 4 above, an effective focal length of the first group (L1-L4) is −39.0705 mm and an effective focal length of the second group (L5-L8) is 12.3707 mmg. Thus, by using a material having a negative DN/DT value for a lens, for example, the fifth lens L5, the seventh lens L7, and the eighth lens L8, among the lenses of the second group having a relatively short effective focal length, it is possible to form the lens array 100 such that a variation in refractive index of a lens at a high temperature is reduced and an overall absolute DN/DT value of the first through eighth lenses L1 through L8 is reduced, thereby reducing, or alternatively, minimizing, a change in optical performance occurring by heat.

That is, lenses having a negative DN/DT value in a high temperature range are concentrated in the second group, and the effective focal length of the first group is a negative value and the effective focal length of the second group is a positive value. Thus, a temperature-based compensation relationship may be established and a variation in overall effective focal length may be reduced, and it is thus possible to provide a stable image despite a change in temperature.

As described above, a head-up display lens system for preventing a ghost image may be provided to prevent the generation of a ghost image and provide a high-resolution image by forming a fifth lens disposed adjacent to a diaphragm to be concave towards a screen.

The head-up display lens system may have or satisfy a thermal compensation characteristic to inversely compensate for a change in focal length occurring due to a change in length of a lens at a high temperature by verifying a refractive power of each of lenses, and selecting a material having a negative DN/DT value at a high temperature for a lens having a relatively high refractive power among lenses having a positive focal length.

Such a thermal compensation characteristic may not be greatly dependent on a length and a thickness of a lens, but be determined by, for example, a DN/DT value of a material of a lens, a refractive power of the lens, a positive and negative compensation for refractive power between lens groups. Thus, a material may be selected by specifying a material of a lens and a refractive power of a lens such that the lens system satisfies the thermal compensation characteristic.

Thus, by restricting a refractive power of a lens to a desired value when designing the lens system, and selecting a lens based on a fact that a DN/DT value, which is an intrinsic property of a lens, differs from each material, it is possible to control a variation in focal length of the first group of lenses and the second group of lenses and design the lens system to have a thermal compensation characteristic.

A distance from a surface of the first lens L1 facing the screen to the diaphragm STO is 24 mm. A distance from the diaphragm STO to a surface of the eighth lens L8 facing the image element 400 is 42 mm. A distance from the diaphragm STO to the image element 400 is 40.8396 mm.

Table 5 below indicates a center thickness of each lens, an edge thickness of each lens (a thickness of a portion on which an outermost ray of light is incident), and a deviation between the thicknesses.

TABLE 5

| Lens number | Center thickness | Edge thickness | Deviation |
|---|---|---|---|
| L1 | 2.000 | 3.766 | −1.766 |
| L2 | 3.608 | 2.219 | 1.389 |
| L3 | 2.500 | 2.068 | 0.432 |
| L4 | 2.935 | 2.676 | 0.259 |
| L5 | 3.414 | 1.803 | 1.611 |
| L6 | 1.000 | 2.954 | 4.954 |
| L7 | 3.334 | 1.815 | 1.519 |
| L8 | 4.576 | 2.403 | 2.173 |

Referring to Table 5, the center thickness and the edge thickness of each of the lenses are restricted to a specific range. In particular, the center thickness and the edge thickness of the sixth lens L6 are restricted to a specific range. Thus, it is possible to reduce or equalize sensitivities when manufacturing the lenses, and improve a tolerance and performance.

As described above, there is provided a head-up display lens system that is designed to prevent generation of a ghost image and provide a high-resolution image by forming a lens disposed adjacent to a diaphragm to be concave towards a screen.

For example, a head-up display lens system including a total of eight lenses may be provided to prevent generation of a ghost image and provide a high-resolution image as described herein. The lens system may prevent generation of a ghost image by forming a fifth lens disposed adjacent to a diaphragm to be concave towards a screen.

In detail, a high-resolution and high-performance, and compact lightweight head-up display lens system may be provided as described. The lens system may prevent generation of a ghost image, satisfy a thermal compensation characteristic, and provide a stable image despite a change in temperature by setting a DN/DT value for each of first through eighth lenses and a DN/DT value for a lens having a relatively high refractive power, and forming a shape of the fifth lens to be concave towards a screen.

In addition, a high-resolution and high-performance, and compact lightweight head-up display lens system may be provided as described herein. The lens system may compensate for a degradation of resolution by appropriately distributing refractive powers of lenses included in the lens system, setting a shape of each of the lenses, for example, a concave shape, a convex shape, and a meniscus shape, using a glass material insensitive to a change in temperature, selecting a material having a negative or positive DN/DT value, disposing each lens at an appropriate position in a lens array, and allowing a focal length to change when a refractive index changes by heat and a set position of a lens changes by heat.

In addition, the head-up display lens system may establish an effective temperature compensating relationship between a first group of lenses and a second group of lenses in an environment, for example, at a high temperature, and thus prevent generation of a ghost image, by setting a position of a diaphragm, appropriately distributing refractive powers of the first group of lenses and the second group of lenses based on the position of the diaphragm, setting a material for each of the first group and the second group, and appropriately setting an effective focal length of each of the lenses included in the first group and the second group.

1. A lens system for a head-up display for preventing a ghost image, comprising:
a first group of lenses arranged towards a screen from a diaphragm; and
a second group of lenses arranged towards an image element,
wherein a lens disposed immediately adjacent to the image element of the diaphragm among the lenses of the second group is formed to be concave towards the screen,
the first group of lenses has a negative refractive power, and the second group of lenses has a positive refractive power, and
the lens system is configured to satisfy |f1|>|f2|, wherein f1 denotes an effective focal length of the first group and f2 denotes an effective focal length of the second group.

2. The lens system of claim 1, wherein a first lens, a second lens, a third lens, and a fourth lens of the first group are arranged from the screen along an optical axis, and
a fifth lens, a sixth lens, a seventh lens, and an eighth lens of the second group are arranged from the screen along the optical axis,
wherein the fifth lens is formed to be concave towards the screen.

3. The lens system of claim 1, wherein a curvature radius of a lens surface of a fifth lens facing the screen is −100 millimeters (mm) to −30 mm.

4. The lens system of claim 1, wherein a curvature radius of a lens surface of a fifth lens facing the screen is −100 mm to −30 mm, and
lens surfaces of first through fourth lenses, a sixth lens, and a seventh lens facing the image element, and lens surfaces of the first through fourth lenses, the sixth lens, and the seventh lens facing the screen are not all planar.

5. The lens system of claim 1, wherein each of a fifth lens, a seventh lens, and an eighth lens of the second group satisfies 40.00<P<70.00, wherein P denotes a refractive power.

6. The lens system of claim 5, wherein the fifth lens, the seventh lens, and the eighth lens have a refractive power greater than a refractive power of a third lens, and
the fifth lens, the seventh lens, and the eighth lens have a negative DN/DT (abs.) (temperature coefficients of refractive index [10⁻⁶/° C. at 632.8 nm]) value in a temperature range from 60° C. to 80° C.

7. The lens system of claim 1, configured to satisfy −3.5<f1|/f2<0, wherein f1 denotes the effective focal length of the first group and f2 denotes the effective focal length of the second group.

8. The lens system of claim 1, configured to satisfy f2/F>1.1, wherein f2 denotes the effective focal length of the second group and F denotes an overall effective focal length of the lens system.

9. A lens system for a head-up display for preventing a ghost image, comprising:
a first group of lenses arranged towards a screen from a diaphragm; and
a second group of lenses arranged towards an image element,
wherein a first lens, a second lens, a third lens, and a fourth lens of the first group are arranged from the screen along an optical axis, and
a fifth lens, a sixth lens, a seventh lens, and an eighth lens of the second group are arranged from the screen along the optical axis,
wherein the first group has a negative refractive power and the second group has a positive refractive power, and
the lens system is configured to satisfy |f1|>|f2|, wherein f1 denotes an effective focal length of the first group and f2 denotes an effective focal length of the second group,
wherein a curvature radius of a lens surface of the fifth lens facing the screen is −100 millimeters (mm) to −30 mm, and lens surfaces of the first through fourth lenses, the sixth lens, and the seventh lens facing the image element and lens surfaces of the first through fourth lenses, the sixth lens, and the seventh lens facing the screen are not all planar, and
the first through eighth lenses are formed of an optical material.
